(19) United States
(12) Patent Application Publication
(10) Pub. No.: US 2019/0220588 A1
(43) Pub. Date: Jul. 18, 2019

(54) PROTECTING AGAINST PASSCODE DETECTION BY DEVICE SENSORS

(71) Applicant: CA, Inc., New York, NY (US)

(72) Inventor: Gaurav Agarwal, Bangalore (IN)

(21) Appl. No.: 15/874,711

(22) Filed: Jan. 18, 2018

(51) Int. Cl. G06F 21/45; G06F 21/36; G06F 3/01; G06F 3/0488

(52) U.S. Cl. CPC G06F 21/45; G06F 3/04886; G06F 3/016; G06F 21/36

(57) ABSTRACT

A mobile computing device causes a user interface to be displayed on a touch-screen display of the mobile computing device. The mobile computing device includes one or more motion sensors configured to detect movement of the mobile computing device. In response to detection of a particular touch input to the user interface, the mobile computing device generates a randomized value associated with the particular touch input. The mobile computing device further causes a first vibration of the mobile computing device in response to the particular touch input, wherein at least one characteristic of the first vibration is randomized based on the randomized value.

### BACKGROUND

### Technical Field

Embodiments described herein are related to the field of computing devices, and more particularly to securing passcode entry on a mobile computing device.

### Description of the Related Art

Mobile computing devices, such as, for example, smart phones, tablets, and other mobile and/or wearable devices, may be used to access a wide variety of sensitive information by a user. To access such information, an application or a server accessed via a web browser may request a passcode from the user. Some mobile computing devices include one or more motion sensors, such as accelerometers and gyroscopes, that are capable of detecting various movements of the computing device, including tilt and vibration. A paper published in the International Journal of Information Security by researchers at Newcastle University (Mehrnezhad, M., Toreini, E., Shahandashti, S. F. et al. Int. J. Inf. Secur. (2017)), demonstrated an ability to use information retrieved from motion sensors to accurately determine information being entered into such computing devices, particularly a user passcode. In their experiment, the Newcastle researchers were able to able to run a key logging program that is written in JavaScript and executed on a target phone simply by having the user visit a website that hosts the code. With the key logging program running in the background without the user's knowledge, the researchers were able to access motion sensor data from the phone while the user tapped in their passcode, and, by running software to analyze the data, were able to determine a user's four-digit passcode with a 74% success rate in a first attempt to login to the user's phone. Given three attempts to determine the passcode, they were successful in 94% of the attempts.

### SUMMARY OF THE EMBODIMENTS

Various embodiments of a sensor network are disclosed. Broadly speaking, apparatuses and techniques are contemplated that use randomization to defeat attempts to determine user inputs to a touch interface of a computing device such as a mobile phone. In one embodiment, a method is contemplated in which a mobile computing device may cause a user interface to be displayed on a touch-screen display of the mobile computing device. The mobile computing device includes one or more motion sensors configured to detect movement of the mobile computing device. In response to detection of a particular touch input to the user interface, the mobile computing device may generate a randomized value associated with the particular touch input. The mobile computing device may further cause a first vibration of the mobile computing device in response to the particular touch input. At least one characteristic of the first vibration may be based on the randomized value.

In another embodiment, a method is contemplated in which an application executing on a mobile computing device may determine that a user interface is to be displayed on the touch-screen display. The mobile computing device may have a touch-screen display and one or more motion sensors that detect movement of the mobile computing device. The application may randomly select a plurality of layout characteristics of a template of the user interface to be altered, and cause the user interface to be displayed on the touch-screen display with a layout based on the template and the altered plurality of layout characteristics.

### BRIEF DESCRIPTION OF THE DRAWINGS

The following detailed description makes reference to the accompanying drawings, which are now briefly described.

FIG. 1 illustrates a block diagram of an embodiment of a mobile computing device and associated applications.

FIG. 2 shows a block diagram of the embodiment of the mobile computing device and an application with a user interface.

FIG. 3 depicts a block diagram of an embodiment of a user interface displayed on the mobile computing device at two points in time.

FIG. 4 illustrates a flow diagram for an embodiment of a method for receiving a passcode using a displayed user interface.

FIG. 5 shows a block diagram of the embodiment of the mobile computing device and an application with a different user interface.

FIG. 6 depicts a block diagram of an embodiment of a user interface on the mobile computing device displayed at different locations at two points in time.

FIG. 7 illustrates a block diagram of an embodiment of a user interface on the mobile computing device displayed with different sizes at two points in time.

FIG. 8 shows a block diagram of an embodiment of a divided user interface on the mobile computing device displayed with different locations at two points in time.

FIG. 9 presents a flow diagram for an embodiment of a method for displaying a user interface with random layout characteristics.

FIG. 10 depicts a block diagram of an embodiment of a user interface displayed on the mobile computing device with a different highlighted portion at two points in time.

FIG. 11 illustrates a flow diagram for an embodiment of a method for highlighting portions of a user interface while receiving a data input sequence.

FIG. 12 shows a block diagram of the embodiment of the mobile computing device and an application with another user interface.

FIG. 13 depicts a block diagram of an embodiment of a user interface displayed on the mobile computing device with different layouts at two points in time.

FIG. 14 presents a flow diagram for an embodiment of a method for altering a layout of a user interface to receive a data input sequence.

FIG. 15 illustrates a block diagram of an embodiment of a mobile computing device.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

As used throughout this disclosure, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or is a factor that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION OF EMBODIMENTS

By using motion sensors commonly included in mobile computing devices, a hacker may be capable of determining information, such as a user's passcode, based on motion data captured while the user is typing the passcode onto a user interface displayed on a touch-screen. To acquire the motion data, the hacker may simply need to install a key logging program on the user's phone. One known method for installing a program without the user's knowledge includes using a JavaScript key logging program that runs when the user visits a web site that hosts the program, and then luring the user to visit the website under false pretenses. Another method involves embedding a key logging program in another, seemingly innocuous application that may be offered through an online application store.

Once the key logging program is installed and active on the user's phone, motion data may be captured and sent to the hacker via a web site, an email, a text message, or other similar data transmission. On some phones, the motion sensor data is not secured, and therefore, is accessible by any application running on the phone. The key logging program may monitor motion sensor data for sudden changes in value that may be indicative of a user tapping the touch-screen. This motion data may be logged and then sent to the hacker at certain established intervals, or when a particular amount of data has been logged. This motion data may provide an indication of where on a touch-screen display the user tapped. Using data analysis software to analyze the logged motion data, the hacker may be able to determine an entered passcode by assuming a particular standard layout of the user interface. In some cases, an exact passcode may not be determined, but instead, a number of possible combinations that correspond to the sensed motion data may be small enough that the hacker can discover the correct passcode through trial and error. In short, security flaws in mobile devices may be present that permit unauthorized access to sensitive information such as device passcodes.

Various embodiments of user interfaces are described in this disclosure. The embodiments illustrated in the drawings and described below may provide techniques for reducing risks of a user's passcode being determined by an unauthorized third party, e.g., a hacker.

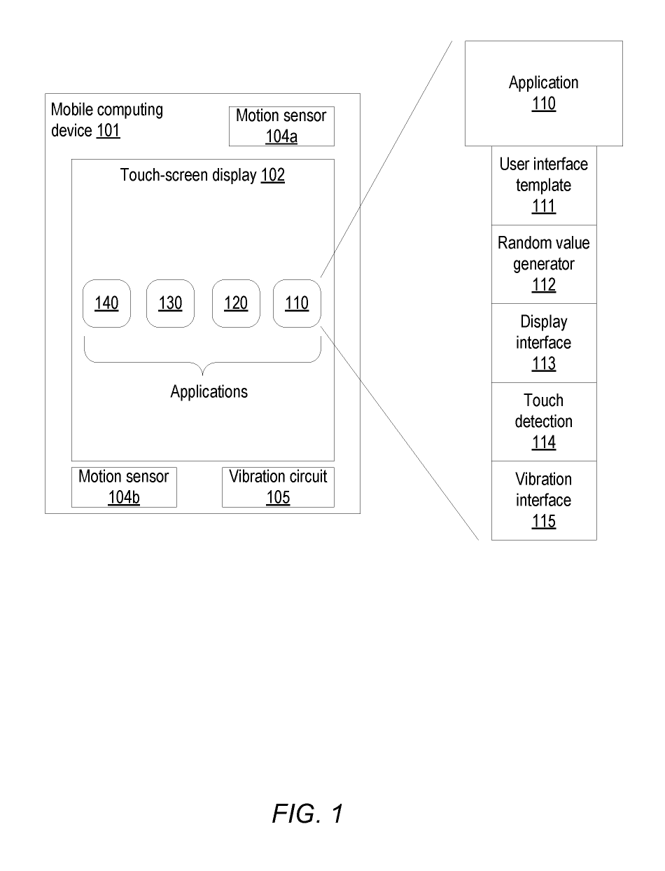

A block diagram of an embodiment of a mobile computing device is shown in FIG. 1. Mobile computing device 101 includes touch-screen display 102, motion sensors 104a and 104b (collectively referred to as motion sensors 104), and vibration circuit 105. An operating system executing on mobile computing device 101 causes four icons for applications 110, 120, 130, and 140 to be displayed on touch-screen display 102. In one possible embodiment, application 110 utilizes five application modules: user interface template 111, random value generator 112, display interface 113, touch detection 114 and vibration interface 115.

It is noted, that as used herein, an “application module” refers to a computer program routine or subroutine that is activated by another program (or other application module) to perform one or more tasks on behalf of the activating program. An application module may be included within an application, within an operating system of a mobile computing device, or may be a library function separate from, but called by an application.

Mobile computing device 101 may correspond to any type of computing device that includes a touch-screen and motion sensors, and is capable of accessing the Internet, including, but not limited to, smart phones, tablet computers, touch-screen notebook computers, smart home devices, smart watches, and the like. Touch-screen display 102, in the illustrated embodiment, corresponds to any suitable type of touch-screen interface capable of displaying images and receiving input via a touch by a user to the screen or to a screen overlay. For example, touch-screen display may correspond to a display screen with capacitive touch sensors, resistive touch sensors, optical wave guides, and the like. Touch-screen display 102 may also include one or more processors and/or control circuits for receiving instructions to display images, as well as detecting touch inputs on the display and determining a location of the touch. Instructions to and touch data from touch-screen display 102 may be communicated via one or more application program interfaces (APIs).

Motion sensors 104, in various embodiments, correspond to accelerometers, gyroscopes, and other similar sensors capable of detecting movement and/or orientation of a sensing element included in mobile computing device 101. Although two motion sensors 104 are shown, any suitable number may be included in mobile computing device 101. For example, in some embodiments, three motion sensors 104 may be used, with one motion sensor each configured to detect motion in one of three directions. Motion sensors 104, in the illustrated embodiment, are thus capable of detecting motion associated with a user tapping or typing on touch-screen display 102. Motion sensors 104 may be accessed using a motion sensor API to read current or most recently sensed motion data.

Vibration circuit 105, in the illustrated embodiment, may be used to provide feedback to a user of mobile computing device 101 by causing mobile computing device 101 to vibrate. In some embodiments, vibration circuit 105 may cause the vibration using an electric motor attached to an imbalanced weight. In other embodiments, a solenoid may be used to vibrate a weight, such as, e.g., a speaker. To control aspects of a given vibration in the illustrated embodiment, instructions are sent to a vibration circuit API. Vibration aspects may include, for example, intensity, duration, and pattern of the given vibration.

In the illustrated embodiment, application 110 corresponds to any type of program that utilizes an interface displayed on touch-screen display 102 to prompt a user to enter a secure passcode. In various embodiments, application 110 may be a program compatible with a particular operating system or may be included as part of a particular operating system. As used herein, a “passcode” refers to any type of code used to identify a user and provide access to sensitive information. In various embodiments, a passcode may correspond to a personal identification number (PIN), password, pass phrase, answer to a security question, and the like. Application 110 may, for example, correspond to a lock screen to gain access to mobile computing device 101, a banking or other financial application, a cloud storage application, a web browser, a web browser extension, and other such applications.

In the illustrated embodiment, application 110 includes computer code that is executable on one or more processor circuits. Thus, various operations described herein may be performed by executing program instructions stored on a non-transitory computer-readable medium and executed by one or more processor circuits (not illustrated). The program instructions may be stored on a non-volatile medium such as flash memory, or may be stored in any other volatile or non-volatile memory medium or device as is well known, such as a ROM or RAM, or provided on any media capable of sharing program code, such as a compact disk (CD) medium, digital versatile disk (DVD) medium, a floppy disk, a flash-based storage, and the like. Additionally, the entire program code, or portions thereof, may be transmitted and downloaded from a software source such as, e.g., via the Internet, or a file transfer protocol (FTP) server, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a mobile computing system such as, for example, in C, C+, HTML, Java, JavaScript, or other such programming languages.

To gain access to information protected by application 110, a user enters a passcode (e.g., for a lock screen). To display a user interface for the user to enter their passcode, application 110 causes user interface template 111 to be displayed on touch-screen display 102 by sending the template to display interface 113. In some embodiments, application 110 causes a random value to be generated using random value generator 112. One or more characteristics of user interface template 111 may be altered based on the random value. User interface template 111 corresponds to a set of data used to define characteristics of an interface to be displayed. For example, user interface template 111 may correspond to a bitmap, vector graphics data, graphics rendering commands, other graphical data, or a combination thereof.

Random value generator 112 may correspond to any suitable software program routine for generating a randomized value. As used herein, a “randomized” or “random” value refers to either a true random value, or to a pseudo random value. Random value generator 112 may, in some embodiments, utilize hardware circuits included in mobile computing device 101 for generating the random value. For example, random value generator 112 may utilize a random number circuit (not shown in FIG. 1) that returns a random value based any suitable circuit, such as, e.g., a free running oscillator, a temperature sensor, a bandgap voltage source, and the like. In some embodiments, random number generator 112 may be included, in whole or in part, within vibration circuit 105. In such an embodiment, in response to a request to cause a vibration, vibration circuit 105 may randomize, using random value generator 112, one or more characteristics of the requested vibration.

Using one or more random values, application 110 may vary one or more characteristics of user interface template 111. For example, a size of user interface template 111 may be increased or decreased, based on the random value, before being displayed. A location of the user interface on touch-screen display 102 may be moved based on the random value. In some embodiments, user interface template 111 may be divided into two or more parts, with each part displayed in a different region of touch-screen display 102. Display interface 113 receives data and/or commands corresponding to the altered user interface and sends these commands to the display API, which provides appropriate instructions for displaying user interface template 111 on touch-screen display 102.

While the altered user interface is displayed on touch-screen display 102, control circuits in touch-screen display 102 may monitor the display for touch inputs. After detecting a touch input, data corresponding to a location of the touch input is passed from a touch sensor API to the application module, touch detection 114. Touch detection 114, in the illustrated embodiment, determines a character value corresponding to the received touch location, based on the altered user interface. This character value may be saved as part of the user's passcode. This process may repeat until the user taps a particular character (e.g., “enter,” “return,” “#,” etc.), or until a predetermined number of characters have been entered, such as a four or six-digit PIN, for example. In some embodiments, in addition to mapping a touch input to a particular character, application 110 may use a random value to cause vibration circuit 105 to generate a particular vibration with one or more random characteristics. Several more embodiments for securing user input are presented below in more detail.

It is noted that by altering one or more characteristics of a displayed user interface, a person with access to motion data sensed while the user taps the touch-screen may not be capable of correlating the motion data to a particular character of the user interface. In some cases, the person may be faced with an increased number of possible combinations of characters that correlate to the sensed motion data, such that a trial and error approach to determine an accurate passcode is impractical.

It is also noted that FIG. 1 is merely an example for demonstrating disclosed concepts. Only components necessary to illustrate the disclosed concepts are shown in FIG. 1. Additional and/or different components may be included in other embodiments. For example, application processors and cellular radios may be included in a smart phone embodiment.

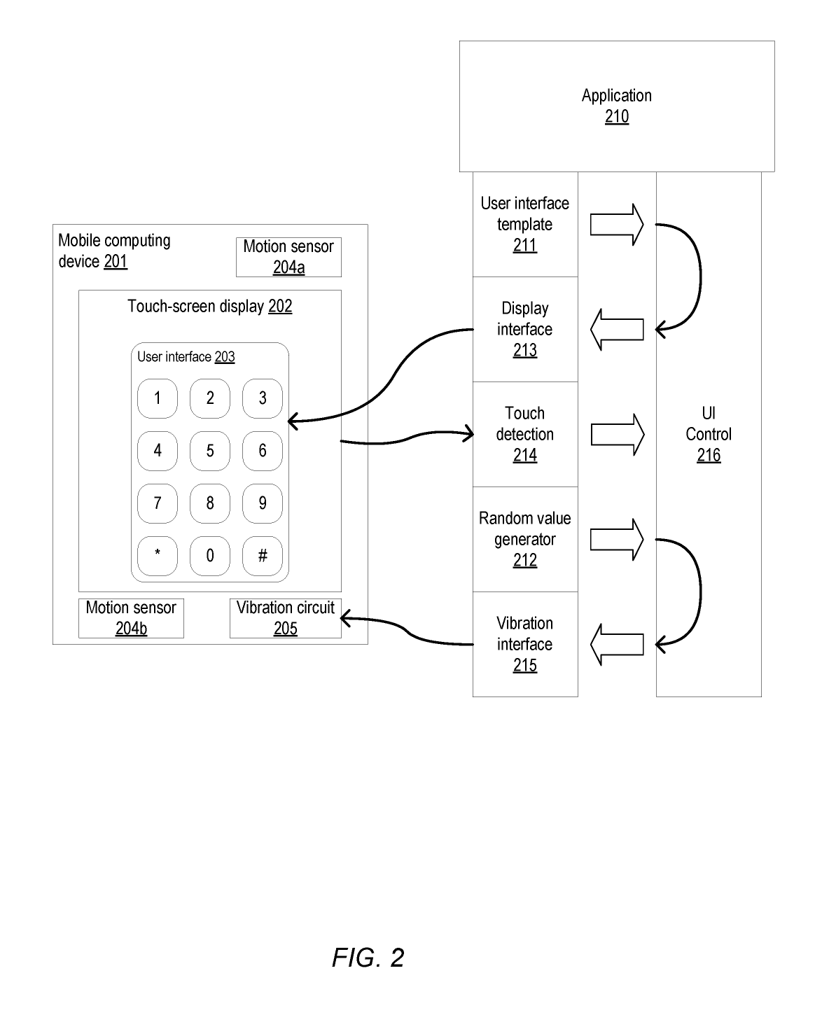

Turning to FIG. 2, an example of the mobile computing device of FIG. 1 is shown with a particular user interface. Mobile computing device 201, in the illustrated embodiment, corresponds to mobile computing device 101 and, therefore, mobile computing device 201, as well as motion sensors 204a and 204b, and vibration circuit 205, operate as described above, except as noted below. Mobile computing device 201 is executing application 210, which includes displaying user interface 203. Application 210 utilizes user interface 203 to receive a passcode from a user. In one embodiment, application 210 utilizes application modules similar to application 110 in FIG. 1, such as user interface template 211, random value generator 212, display interface 213, touch detection 214, and vibration interface 215. Application 210 utilizes another application module, user interface control module (UI control) 216.

In the illustrated embodiment, application 210 executes UI control 216 to cause user interface 203 to be displayed on touch-screen display 202 and receive a passcode from a user. To activate user interface 203, UI control 216 sends a copy of user interface template 211 to display interface 213, which in turn, causes the interface to be displayed on touch-screen display 202. In various embodiments, UI control 216 may or may not alter the copy of user interface template 211 before sending to display interface 213.

In response to detecting, via touch detection 214, an indication that a particular touch input has been received that corresponds to a region of user interface 203, UI control 216 activates random value generator 212 to generate a randomized value associated with the particular touch input. UI control 216 then causes a vibration in mobile computing device 201 in response to the particular touch input. To cause the vibration, UI control 216 sends a command to vibration interface 215, wherein at least one characteristic of the vibration is based on the randomized value. As noted above, the vibration characteristic may correspond to one or more of an intensity, a duration, a pattern, or other suitable characteristic of the vibration. In some embodiments, UI control 216 may select one or more of the vibration characteristics to alter based on a different randomized value.

In various embodiments, touch detection 214 and/or UI control 216 determines a character value associated with the touched region of user interface 203, and saves this character value as a portion of the user's passcode. In response to detecting a subsequent touch input in a region of user interface, corresponding to a next character of the user's passcode input sequence, UI control 216, in some embodiments, causes another vibration in mobile computing device 201. UI control 216 may base the at least one characteristic on another randomized value. By varying the at least one characteristic of the vibration, this second vibration may cause a different output at motion sensors 204a and/or 204b, as compared to the first vibration, even if the first and second vibrations are based on the same user input (e.g., the digit “9” is selected in both cases).

As used herein, “input sequence” refers to a sequence of one or more touch inputs by a user on a touch-screen display corresponding to an entry of a particular passcode or other input string. For example, a particular input sequence may include five consecutive touch inputs corresponding to four digits of a PIN plus a fifth touch to an “enter” key to submit the PIN.

It is noted that the system illustrated in FIG. 2 is merely an example. Although a numeric keypad is shown as the user interface, any type of alpha-numeric interface may be used, including a QWERTY keyboard, as well as various other symbols. Application 210 is illustrated with six application modules: 211 through 216. Functions assigned to each of the application modules are made for clarity. In other embodiments, functions of application 210 may be divided into any suitable number of application modules. In some embodiments, all described functions may be included in application 210 with no division into separate application modules.

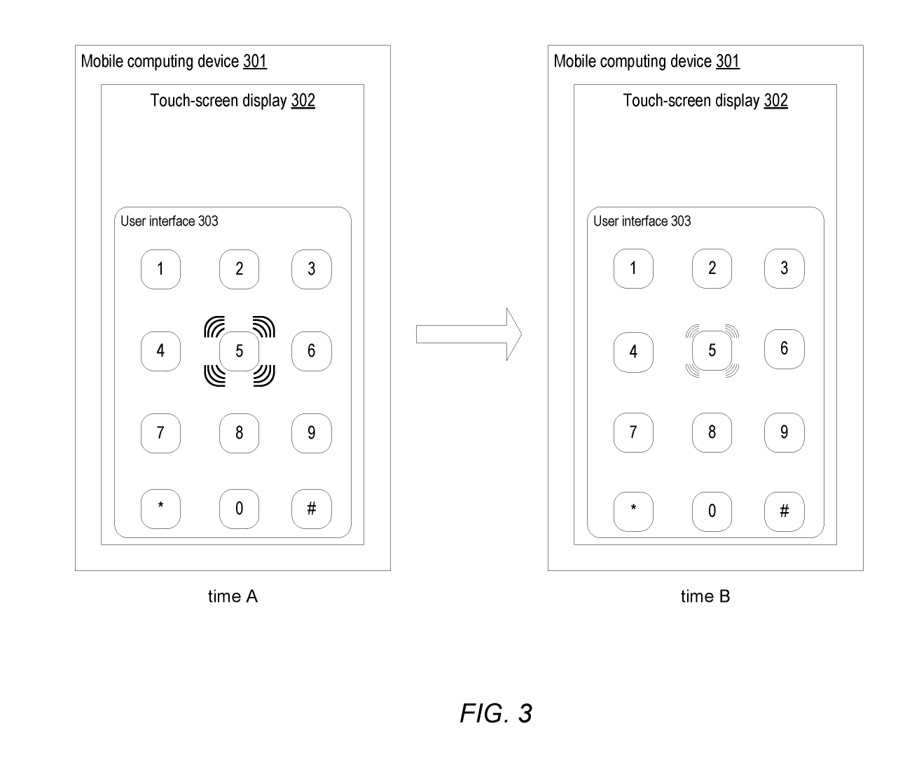

Moving to FIG. 3, an example implementation of application 210 in FIG. 2 running on a mobile device is depicted. Two representations of mobile computing device 301 are shown, illustrating two respective points in time. In the illustrated embodiment, mobile computing device 301 corresponds to mobile computing device 201 described in regards to FIG. 2. Mobile computing device 301 includes touch-screen display 302, which displays user interface 303.

In the illustrated embodiment, application 210 is requesting a passcode from a user of the device and causes mobile computing device to display user interface 303. At time A, the user touches the “5” key. Application 210 detects the touch input, determines that the touch corresponds to an illustrated key in user interface 303, and generates one or more random numbers. Application 310 then causes a first vibration in mobile computing device 301 with at least one characteristic of the vibration (duration, intensity, pattern) determined by one of the one or more random numbers. For example, each random number may, in some embodiments, correspond to an 8-bit value, ranging from “0” to “255.” A value of “0” may correspond to a lowest intensity, or shortest duration vibration. If a pattern of the vibration is being randomized, then the random value may correspond to any one of a number of preset patterns, or may set a particular variable of a given pattern, such as a time between successive vibration pulses, or a number of vibration pulses to generate in succession.

In some embodiments, one random value may both select a particular characteristic to alter as well as set a value for the characteristic. For example, random values from 0-15 may select vibration duration as the characteristic with the duration set to a shortest length with a value of “0” up to a longest length with a value of “15.” Similarly, values of 16-31 may select intensity as the characteristic with the level of the intensity ranging from low (16) to high (31). Other values may correspond to various patterns, such as multiple vibration pulses, each pulse varying between long and short durations. Some random values may correspond to a combination of characteristics to alter, such as, e.g., selecting both an intensity and a number of successive vibration pulses to generate. Many variations of mapping one or more random values into various randomized vibrations may be contemplated for use with the disclosed application.

At time B, following time A, the user touches the “5” key again. As before, application detects the touch input and determines that it corresponds to the “5” key. A new random value is generated and used to alter at least one characteristic of a second vibration, as described above. By randomizing the one or more characteristics of the vibration, motion sensors in mobile computing device 301 (such as, for example, motion sensors 204 in FIG. 2) may sense different motion of mobile computing device 301, resulting in different sensed values, even when the same key on the user interface is selected. This different data from the motion sensors may help to mask the user's selected touch inputs, increasing the difficulty for a hacker to determine the user's passcode from the motion sensor data.

It is noted that FIG. 3 is merely one example used to demonstrate the disclosed concepts. In various embodiments, user interfaces may differ per requirements for a particular embodiment. For example, in some embodiments, an alpha-numeric (e.g., QWERTY) keypad, or other type of interface may be displayed in place of the numeric keypad shown.

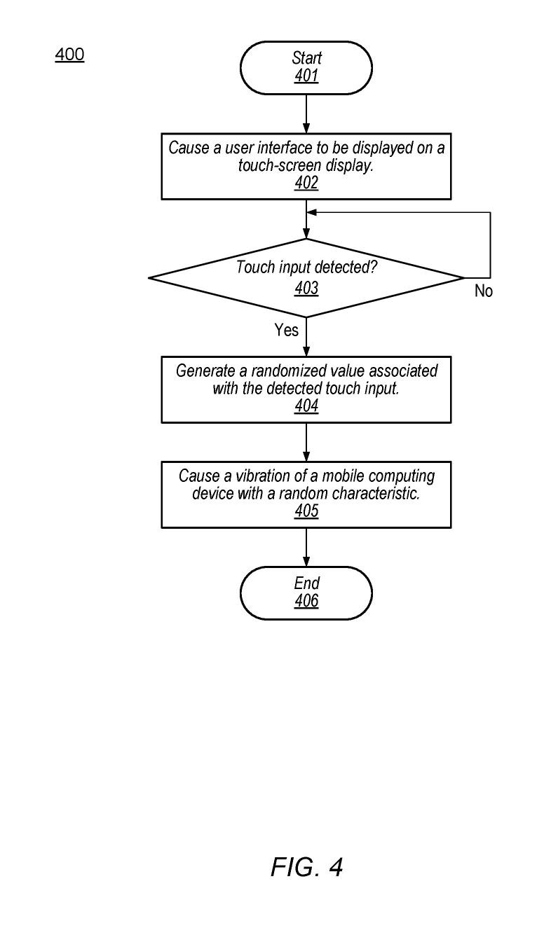

Turning now to FIG. 4, a flow diagram for an embodiment of a method for receiving a passcode is illustrated. Method 400 may be applied to a mobile computing device such as, for example, mobile computing device 201 in FIG. 2, using application 210. Referring collectively to FIG. 2 and the flow diagram in FIG. 4, the method begins in block 401.

An application executing on a mobile computing device causes a user interface to be displayed on a touch-screen display of the mobile computing device (block 402). In the illustrated embodiment, UI control 216 in application 210 causes user interface template 211 to be displayed on touch-screen display 202 using display interface 213 in order to receive a passcode from a user of mobile computing device 201. Mobile computing device 201 includes motion sensors 204a and 204b to detect movement of the mobile computing device. Under some conditions, a hacker may attempt to use data from these motion sensors to determine the passcode that the user enters into user interface 203.

Further operations of method 400 may depend on detection of a particular touch input to the user interface (block 403). Touch detection 214, in application 210, may monitor output from touch-screen display 202, or, in other embodiments, may receive a signal from touch-screen display 202, when touch-screen display 202 detects a touch input. Upon detecting a particular touch input, touch detection 214, in the illustrated embodiment, receives data from touch-screen corresponding to a location on the display where the touch input occurred. If touch detection 214 determines that the location of the touch input corresponds to a valid key of user interface 203, then the method moves to block 404 to generate a random value. Otherwise, the method remains in block 403.

If a touch input corresponding to a key of the user interface is detected, then the application generates a randomized value associated with the particular touch input (block 404). UI control 216 receives data from touch detection 214 corresponding to a particular key of user interface that was touched by the user. In response to this detected touch input, UI control 216 uses random value generator 212 to generate at least one randomized value.

The application causes a first vibration, with at least one characteristic of the first vibration is based on the randomized value, in the mobile computing device in response to the particular touch input (block 405). UI control 216 uses the randomized value to cause vibration circuit 205 to generate a vibration in mobile computing device 201. One or more randomized values may be used to alter one or more characteristics of the first vibration. In some embodiments, the first vibration may result in motion sensors 204a and/or 204b generating data values that correspond more to the first vibration rather than movement caused by the user tapping the user interface, thereby masking the user touch. In other embodiments, the first vibration may cause motion sensors 204a and/or 204b to generate data in addition to data corresponding to the user tapping the user interface. In either embodiment, masked or additional motion sensor data may increase the difficulty for the hacker to determine the user's passcode.

It is noted that method 400 in FIG. 4 is an example embodiment. Variations of the example embodiment are contemplated and may include additional operations. In other embodiments, some operations may be performed in parallel or in a different sequence.

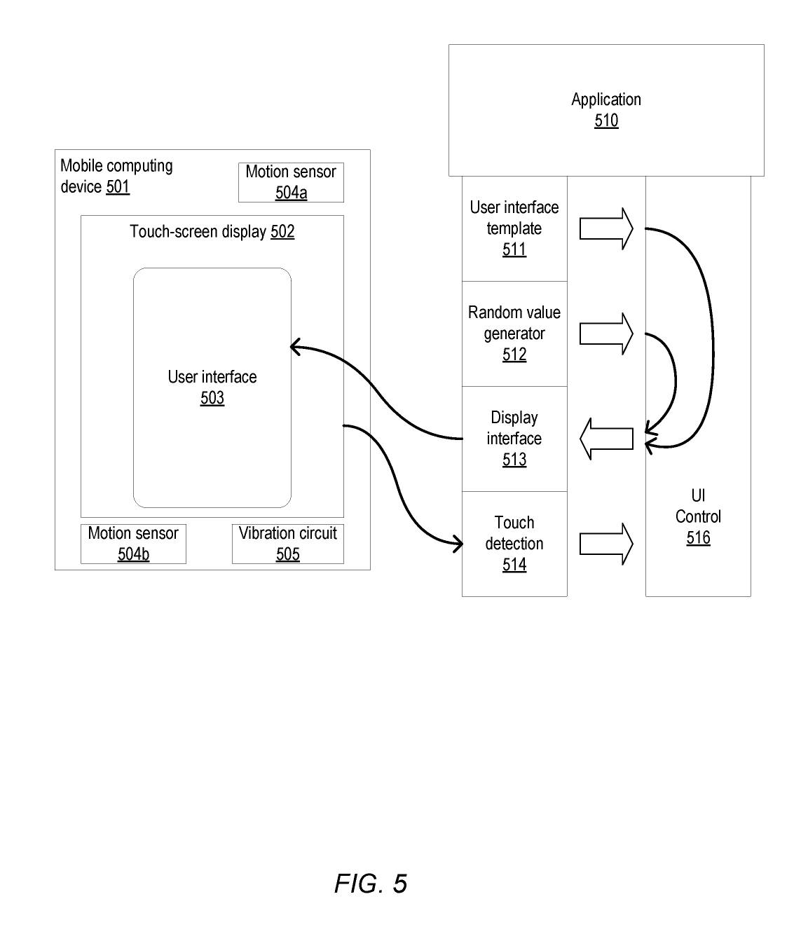

Moving now to FIG. 5, an example of the mobile computing device of FIG. 1 is shown with another user interface. In the illustrated embodiment, mobile computing device 501 corresponds to mobile computing device 101. Mobile computing device 501, as well as motion sensors 504a and 504b, and vibration circuit 505, operate as described above, with exceptions as noted below. Application 510 is running on mobile computing device 501, which causes user interface 503 to be displayed on touch-screen display 502. Using user interface 503, application 510 may receive a passcode from a user. Application 510 includes application modules similar to application 110 in FIG. 1, such as user interface template 511, random value generator 512, display interface 513, and touch detection 514. Application 510 further includes user interface control module (UI control) 516.

In the illustrated embodiment, application 510, executing on mobile computing device 501, determines that a user interface is to be displayed on touch-screen display 502 in order to receive a passcode from a user. To display user interface 503, application 510 activates the application module UI control 516. UI control 516 retrieves a copy of user interface template 511 and, in addition, generates one or more randomized values using random value generator 512. As disclosed above, randomized values may correspond to true random numbers or pseudo-random numbers. UI control 516 randomly selects, using the one or more randomized values, a plurality of layout characteristics of the copy of user interface template 511 to be altered. The characteristics to be altered may include any of a layout of keys of the interface, a size of the interface, a location of the interface on touch-screen display 502, a number of parts comprising the interface, or any other suitable characteristic. The characteristics may be altered by, for example, using a randomized value to scale a size of the interface, either increasing or decreasing the size based on the random value.

After the characteristics have been selected and altered, UI control 516 causes user interface 503 to be displayed on touch-screen display 502 with a layout based on user interface template 511 and the altered plurality of layout characteristics. In some embodiments, a single randomized value may be used to select and alter the plurality of layout characteristics, similar to above descriptions in regards to the vibration characteristics. In other embodiments, a first randomized value may be used for selecting characteristics to alter and at least a second randomized value used for altering the selected characteristics.

In response to detecting a touch input on touch-screen display 502, touch detection 514 receives data corresponding to a location of the detected touch input. Touch detection 514 determines if the detected touch input occurred in a valid part of user interface 503. For example, touch detection determines if the location of the touch input occurred in an area corresponding to a displayed key or button of user interface 503. If so, then a character value corresponding to the touched key is saved as part of the user's passcode. If not, then application 510 may wait for another touch input. In some embodiments, user interface 503 may retain the altered layout for the entirety of a particular user input sequence, i.e., until the user completes the current entry of the passcode. In other embodiments, application 510 may cause the layout to be randomly altered again between one or more valid touch inputs.

It is noted that altering a layout of a user interface may increase a difficulty for a hacker attempting to use data from motion sensors 504a and 504b to determine the user's passcode. By changing where on touch-screen display 502 the user taps to enter a particular character, data values captured by motion sensors 504a and 504b may be unpredictable and differ after each passcode entry.

Application 510, like application 110 in FIG. 1, may correspond to any type of program that utilizes an interface displayed on touch-screen display 502, including, for example, a program compatible with a particular operating system, or program that is part of a particular operating system. In some embodiments, application 510 may correspond to an application module that may be activated by another application executing on mobile device 501. Although arrows shown in FIG. 5 may indicate a communication path directly between application modules 511-514 and UI control 516, in some embodiments, communication between these application modules may occur via application 510.

It is also noted that the embodiment of FIG. 5 is one example. In other embodiments, the mobile computing device may include any suitable number of circuit blocks not shown in FIG. 5. In some embodiments, the application may include different application modules than the ones illustrated.

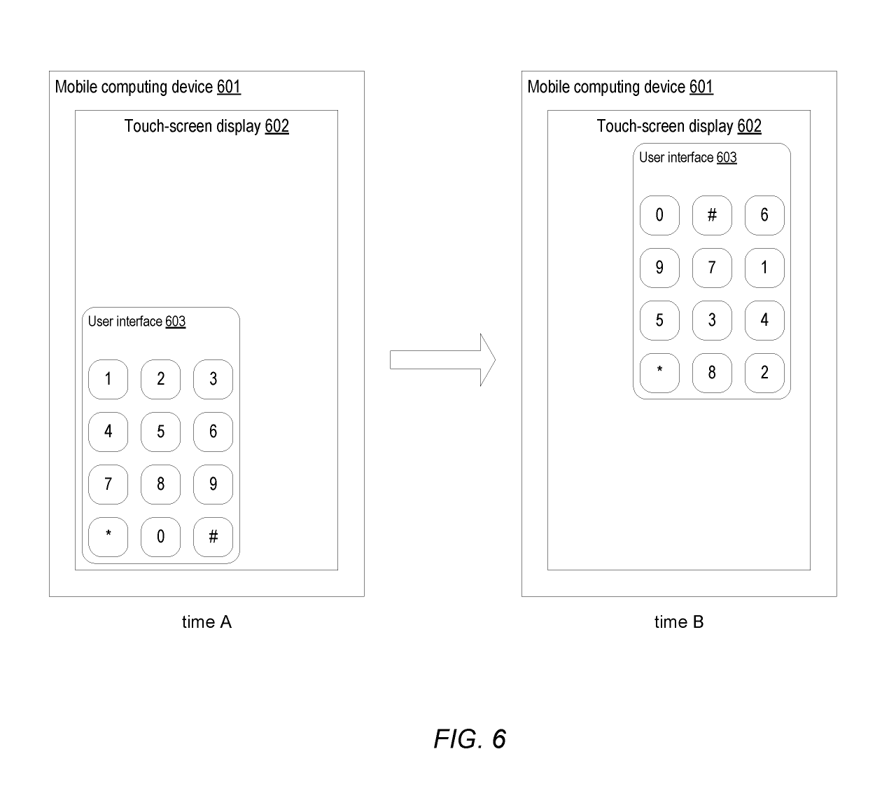

Several examples of characteristics of user interfaces that may be altered are illustrated in FIGS. 6, 7, and 8. Each of FIGS. 6, 7, and 8 show a user interface displayed on a touch-screen display of a mobile device at two points in time, time A and time B. In the illustrated embodiments, mobile computing devices 601, 701, and 801, may correspond to mobile computing device 501 in FIG. 5.

FIG. 6 illustrates two views of user interface 603 in which a location of the interface is altered between time A and time B. In addition to the location, an order in which keys of user interface 603 are displayed is altered between time A and time B. An application, such as, e.g., application 510 in FIG. 5, generates one or more randomized values to be used to select a location on touch-screen display 602 to place user interface 603. In various embodiments, the location may be selected from a predetermined set of locations on touch-screen display 602, or random x-y coordinates for rendering user interface 603 may be determined from the one or more random values. For example, a first random value may determine an offset from a default x-coordinate and a second random value may determine a similar y-coordinate offset. In some embodiments, user interface 603 may relocate between each valid touch of a key of the interface, while in other embodiments, user interface 603 may be relocated before a start of a user input sequence for a particular user passcode and remain in the same location until the passcode has been entered. By changing a location of the user interface, motion sensors (not illustrated) in mobile computing device 601 may sense different motion data when a same interface key is touched at times A and B.

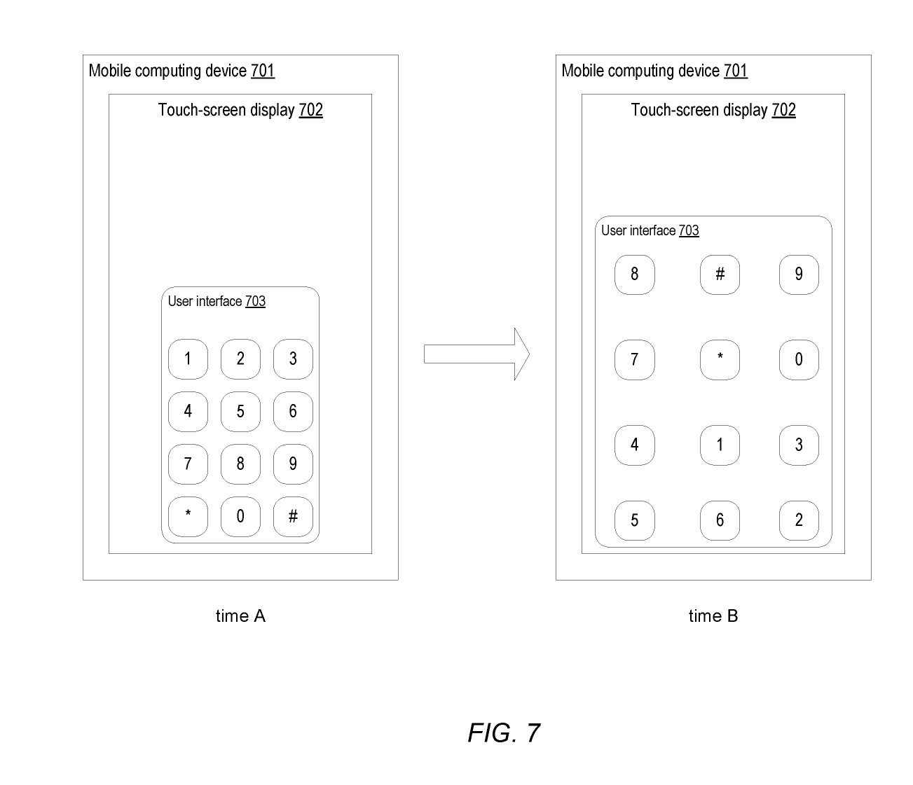

FIG. 7 shows two views of user interface 703 in which a size of the interface is altered between time A and time B. Similar to FIG. 6, the order in which the keys of user interface 703 are displayed is also altered between time A and time B. Again, an application such as application 510 may generate one or more randomized values to determine alterations to the size of user interface 703. For example, application 510 may generate two random values. A first random value may determine a scaling factor for an x-dimension of the interface while a second value determines a scaling factor for a y-dimension. In some embodiments, sizes of the keys of the interface may be scaled by a similar factor, while in other embodiments (such as shown in FIG. 7), the keys may remain a same size. As with the example of FIG. 6, the size of user interface 703 may be varied between each valid key touch, or between entries of the user passcode. Similar to changing a location of the user interface, changing a size of the interface may cause motion sensors in a mobile computing device to sense different motion data when a same key is touched at times A and B.

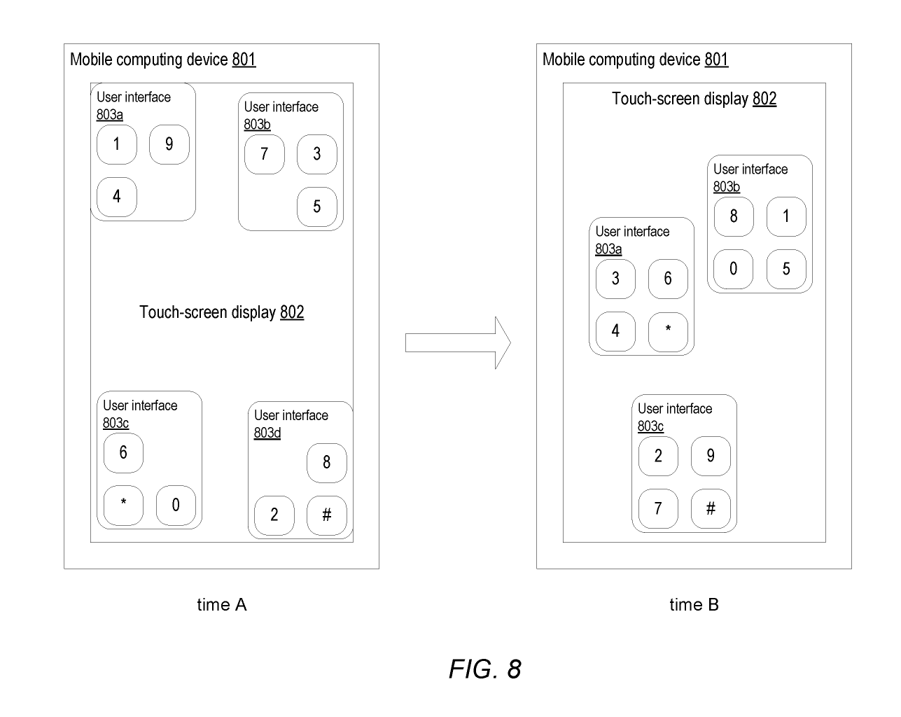

FIG. 8 demonstrates another embodiment of how a layout of a user interface may be altered. In the illustrated embodiment, user interface 803 is divided into four parts, 803a through 803d. At time A, an application, such as application 510 in FIG. 5, may utilize one or more random values for determining a number of parts for user interface 803, where on touch-screen display 802 to locate each part of the interface, and which keys are placed into which part. Moving to time B, application 510, based on a new set of randomized values, alters a number of parts for user interface 803 from four to three (803a-803c), the location of each the three parts on the display, and the keys that are included in each of user interface parts 803a to 803c. In some embodiments, a size of each of parts 803a-803c may also be altered. As with the examples of FIGS. 6 and 7, the alterations of user interface 803 may be varied between each valid key touch, or between entries of the user passcode. A touch to a particular key (e.g., “6”) at time A may result in different data in motion sensors of mobile computing device 801 as compared to a touch to the same “6” key at time B.

It is noted that the embodiments illustrated in FIGS. 6, 7, and 8 are examples for demonstrating disclosed concepts. In other embodiments, additional or different characteristics of a user interface may be altered. In some embodiments, various combinations of the characteristics illustrated in FIGS. 6, 7, and 8 may be altered for a particular interface.

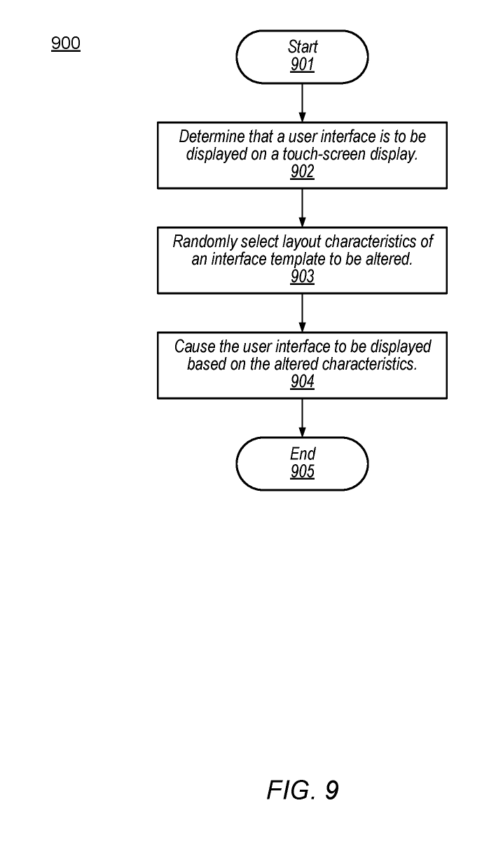

Turning to FIG. 9, a flow diagram for an embodiment of a method for displaying a user interface is illustrated. Method 900 may be applied to a mobile computing device such as, for example, mobile computing device 501 in FIG. 5, using application 510. In some embodiments, method 900 may be performed before method 400 in FIG. 4 is performed. Referring collectively to FIG. 5 and the flow diagram in FIG. 9, the method begins in block 901.

An application executing on a mobile computing device determines that a user interface is to be displayed on a touch-screen display (block 902). In the illustrated embodiment, application 510 determines that user interface 503 is to be displayed on touch-screen display 502. The determination may correspond to a launch of application 510, a user of mobile computing device 501 attempting to access protected information or features associated with application 510, or the user touching a particular key of a different interface, such as a “login” button on a startup screen. To mitigate against a hacker using data from motion sensors 504a and/or 504b in an attempt to determine the user's passcode, application 510 activates the application module UI control 516 to determine a layout for and to display user interface 503.

The application randomly selects a plurality of layout characteristics of a template of the user interface to be altered (block 903). UI control 516, in the illustrated embodiment, retrieves a copy of user interface template 511. To select characteristics of user interface template 511 to alter, UI control 516 uses random value generator 512 to generate one or more randomized values. Based on the one or more randomized values, UI control 516 selects a plurality of characteristics to alter. For example, UI control 516 may select two or more characteristics from a group including an order of keys of user interface 503, a size of the interface, a location of the interface on touch-screen display 502, a number of separate parts that comprise the interface, and other such characteristics.

The application causes the user interface to be displayed on the touch-screen display with a layout based on the template and the altered plurality of layout characteristics (block 904). In some embodiments, UI control 516 may use the same randomized values used for selecting the characteristics to alter, to determine how to alter the selected characteristics. In other embodiments, one or more addition randomized values may be generated to determine an amount of alteration for a selected characteristic. For example, a first randomized value may determine that size of the interface is to be altered, while second and third randomized values are used as scaling factors for a height and a width, respectively, of user interface 503. After the alterations have been made to the copy of user interface template 511, UI control 516 sends the altered copy of the template to the application module display interface 513, which interfaces with touch-screen display 502 to display the altered copy as user interface 503.

It is noted that method 900 is merely an example of a process for displaying a user interface with random characteristics. Only operations related to altering and displaying a user interface are illustrated. In other embodiments, additional operations may be included.

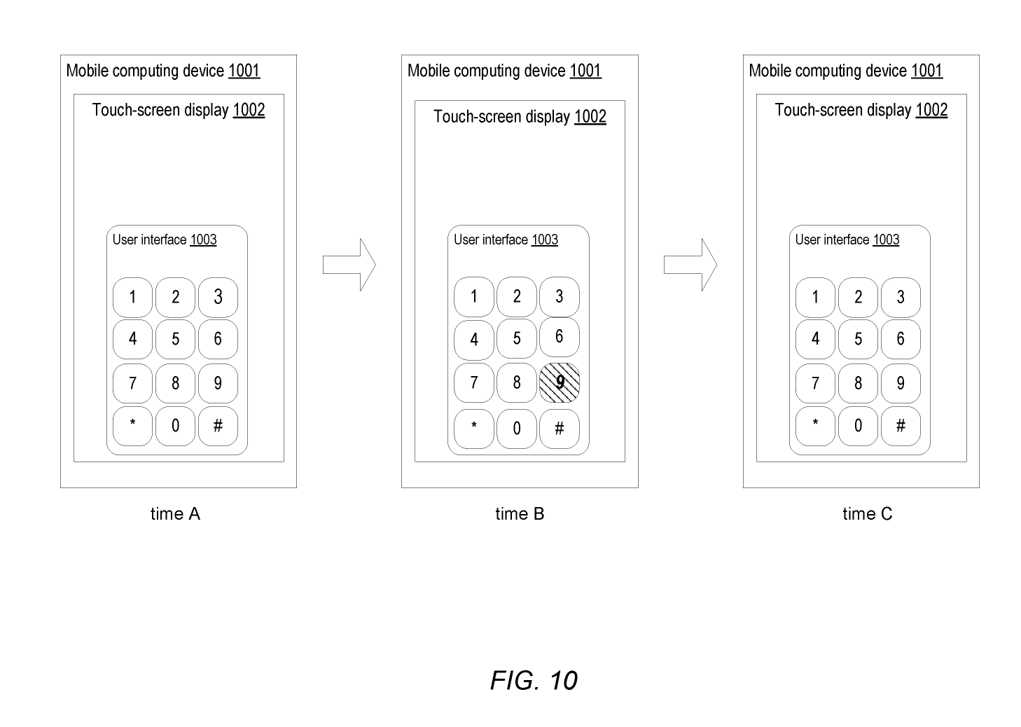

Moving to FIG. 10, a user interface displayed on a touch-screen display of a mobile device at three points in time (times A, B, and C) is depicted. In the some embodiments, mobile computing device 1001 may correspond to mobile computing device 201 in FIG. 2, or mobile computing device 501 in FIG. 5. The embodiment of FIG. 10 depicts another concept for disrupting motion sensor data while a user enters a passcode on mobile computing device 1001. In the illustrated embodiment, user interface 1003 highlights a key to be touched by the user, while the user is entering a passcode.

An application, such as, for example, applications 210 or 510 in FIGS. 2 and 5, respectively, randomly selects a key on user interface 1003 to highlight, prompting the user to touch the highlighted key before entering another character of the user's passcode. At time A, user interface 1003 is displayed on touch-screen display 1002 with no keys highlighted. The user may enter a next (or first) character of the passcode by touching the respective key on user interface 1003. The application saves the corresponding character as part of the passcode. In addition, the application generates a randomized value (utilizing a random number generator module, such as, e.g., random value generators 212 or 512) and selects a key of user interface 1003. In the illustrated embodiment, the “9” key is selected and at time B, the “9” key on user interface 1003 is highlighted. To highlight the key, any suitable characteristic of the key may be altered, such as, for example, the size, color, font, brightness, shape, or any suitable combination thereof.

The highlights on the “9” key prompt the user to touch this key. The character corresponding to the highlighted key, i.e., “9” in this example, is discarded and, therefore, not included as part of the user's passcode. In some embodiments, if a key other than the highlighted key is touched, the character associated with the other key is saved as a next character of the passcode. The highlighted key may remain highlighted, and the passcode entry may not be completed, until the user touches this key. In other embodiments, any other touched key may be ignored until the highlighted key is touched.

At time C, the highlighted key has been touched and the highlights removed from the key. The user may now enter a next character of the passcode. After touching a next key of the interface, the application may randomly select another key to highlight. In some embodiments, the application may utilize a randomized value to determine if a key of user interface 1003 is to be highlighted after each touch of a character of the passcode. In other embodiments, a key may be selected to be highlighted after a predetermined number of characters of the passcode have been entered. By adding additional touches to the user input sequence, motion sensors in mobile computing device 1001 may sense extra data that is not related to the user's passcode, thereby hindering attempts by a hacker to determine the passcode from the motion sensor data.

It is noted that the example of FIG. 10 is just one embodiment. Only functional blocks for demonstrating the disclosed concepts have been illustrated. In other embodiments, additional functional blocks and application modules may be included. Furthermore, concepts associated with the illustrated embodiment may be combined with concepts presented throughout this disclosure.

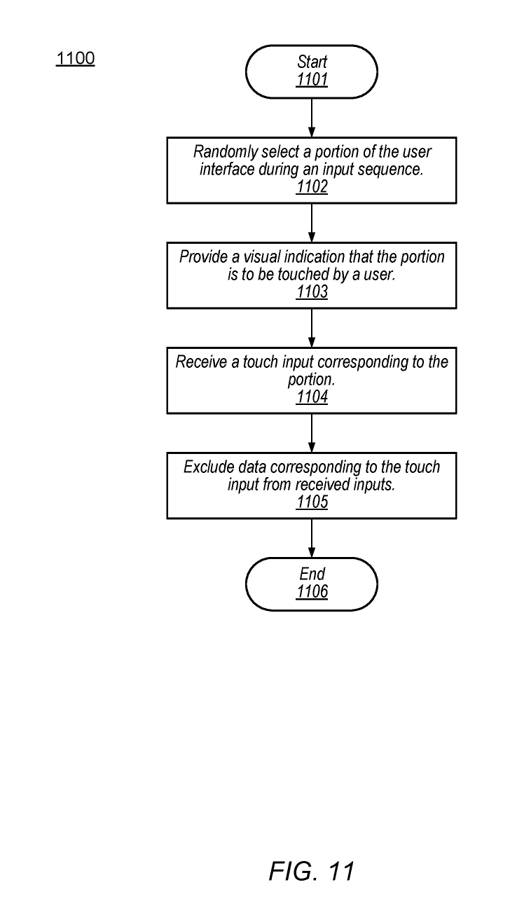

Proceeding now to FIG. 11, a flow diagram is illustrated that depicts an embodiment of a method for highlighting portions of a user interface while receiving a data input sequence on a mobile computing device. Method 1100 may be applied to any of the mobile computing devices disclosed herein, such as, for example, mobile computing devices 201 and 501 in FIGS. 2 and 5, respectively. Referring to FIG. 2 and the method of FIG. 11, Method 1100 begins in block 1101 with a user input sequence either starting or in progress on mobile computing device 201.

An application randomly selects, during a user input sequence, a particular portion of a user interface (block 1102). In the illustrated embodiment, UI control 216 in application 210 uses random value generator 212 to generate a randomized value. Based on this randomized value, UI control 216 selects a key of user interface 203 to highlight. In some embodiments, UI control 216 may select the random key in response to a user having touched a key to enter a character of the user's passcode. In other embodiments, UI control 216 may select a random key at predetermined points in a particular user input sequence.

The application provides a visual indication that the particular portion of the user interface is to be touched by a user (block 1103). UI control 216, using display interface 213, alters at least one characteristic of the selected key. Selected characteristics may include any combination of size, color, font, brightness, or shape of the key. In some embodiments, two or more keys may be selected and highlighted.

The application receives a touch input corresponding to the particular portion of the user interface (block 1104). In the illustrated embodiment, the user is prompted to touch the highlighted key. The prompt may correspond to words displayed in conjunction with user interface 203, or to instructions provided when application 210 is installed on mobile computing device 201. Touch-screen display 202 sends a signal to application 210, via the application module touch detection 214, signaling that a touch to the display has occurred. Touch-screen display 202 also sends data corresponding to a location of the touch.

The application excludes data corresponding to the touch input from received inputs during the input sequence (block 1105). Touch detection 214 receives the data corresponding to the location of the touch and determines which key corresponds to that location. If the highlighted key corresponds to the location, then the character represented by the highlighted key is ignored and not added to the user input sequence for this particular touch. In some embodiments, if the location does not correspond to the highlighted key, then the method may return to block 1104 until another touch is detected. In other embodiments, a character corresponding to the touched key may be determined and added to the user input sequence, while the highlighted key remains highlighted. The method ends in block 1106. Method 1100 may, in some embodiments, be repeated after a next character of the user's passcode is entered.

It is noted that Method 1100 is one example. In other embodiments, additional operations may be included. Method 1100 may be performed in conjunction with one or more other methods disclosed herein.

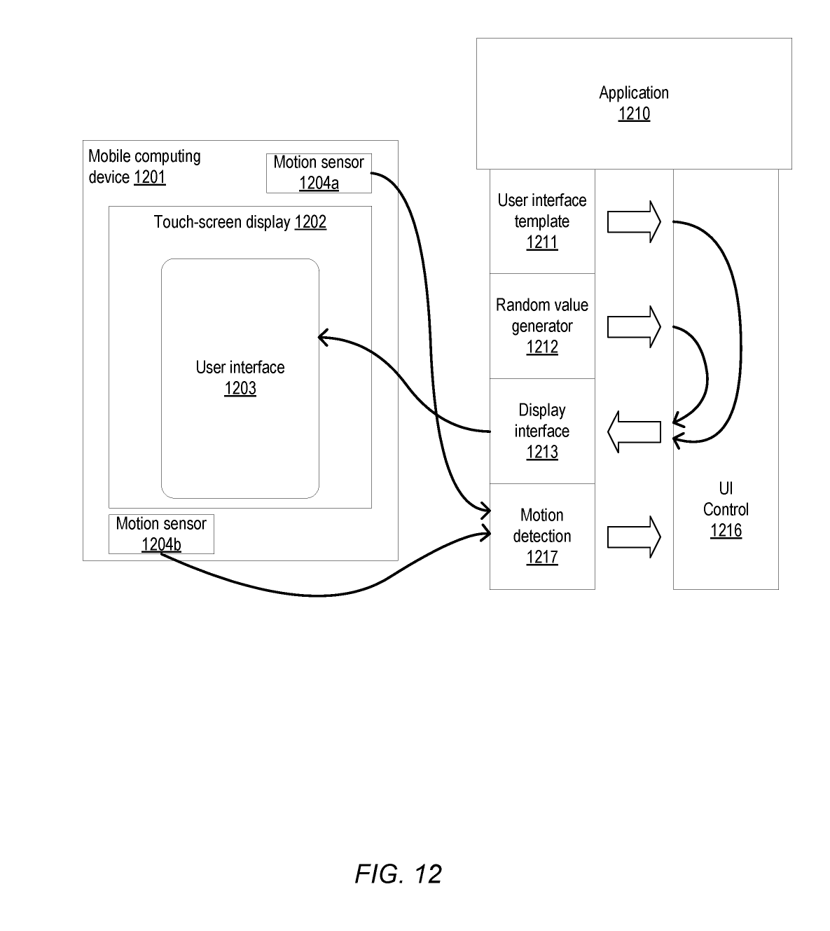

Turning now to FIG. 12, an example of the mobile computing device of FIG. 1 is shown with another user interface. In the illustrated embodiment, mobile computing device 1201 corresponds to mobile computing device 101. Mobile computing device 1201, as well as motion sensors 1204a and 1204b, and vibration circuit 1205, operate as described above, with exceptions as noted below. Mobile computing device 501 executes application 1210 resulting in user interface 1203 being displayed on touch-screen display 1202. Using user interface 1203, application 1210 may receive a passcode from a user. Application 1210 utilizes several application modules, including user interface template 1211, random value generator 1212, display interface 1213, UI control 1216, and motion detection 1217.

In some embodiments, application 1210 may correspond to an application with access to sensitive information and, therefore, includes application modules for generating a user interface and securely receiving a user passcode using the interface. In other embodiments, application 1210 may correspond to an application that is activated by other applications for the purpose of securely receiving a user passcode. After determining that user interface 1203 is to be displayed to receive a user passcode, application 1210 activates UI control 1216 which retrieves a copy of user interface template 1211. UI control 1216 then randomly selects a layout for user interface 1203 by using random value generator 1212 to generate one or more random values. UI control 1216 alters the copy of user interface template 1211 by dividing the template into two or more parts based one of the one or more random values. Also based on the one or more random values, keys of the copy of user interface template 1211 are randomly assigned to the two or more parts.

After the copy of user interface has been altered, UI control 1216 causes user interface 1203 to be displayed on touch-screen display 1202 such that the two or more parts of user interface 1203 are displayed in different regions of the display. To display user interface 1203, UI control 1216 sends the altered copy of user interface template 1211 to display interface 1213 which then causes touch-screen display 1202 to show user interface 1203 with each part of the interface displayed in a respective corner of touch-screen display 1202.

To select a particular key of user interface 1203, the user may tilt mobile computing device 1201 towards the corner or touch-screen display 1202 that is displaying the desired key. Application module motion detection 1217 may monitor data sensed by motion sensors 1204a and 1204b and determine, based on this monitored data, that a user has tilted mobile computing device 1201 towards a particular corner to select that corner. If only four or fewer keys are included in user interface 1203, then UI control 1216 determines which key is displayed in the selected corner and save a character corresponding to the user input sequence. If user interface 1203 includes more than four keys, then multiple keys are displayed in each corner of the display. After selecting a particular corner, user interface 1203 is modified.

All keys displayed in the selected corner are redistributed to various parts of the interface, and the keys that were displayed in the unselected corners are excluded. UI control 1216 may generate one or more additional randomized values to determine how many parts are included in the redistributed interface and which keys are placed in each part. UI control 1216 then causes the various parts of the redistributed interface to be displayed in two or more corners of touch-screen display 1202. The user may again tilt mobile computing device 1201 towards the corner that includes the desired key, causing motion detection 1217 to select this corner. This process may continue until a single key is included in the selected corner. A character corresponding to the single key is then added to the user input sequence. By using a tilt of a mobile computing device to select a particular part of a user interface, and randomly placing keys of the interface in each part, data sensed by motion sensors in the device may be difficult to decode into the user's passcode.

It is noted that the embodiment of FIG. 12 is merely an example. In other embodiments, additional functional blocks and/or additional application modules may be included. In some embodiments, features presented in FIG. 12 and described above may be combined with features from other embodiments disclosed herein.

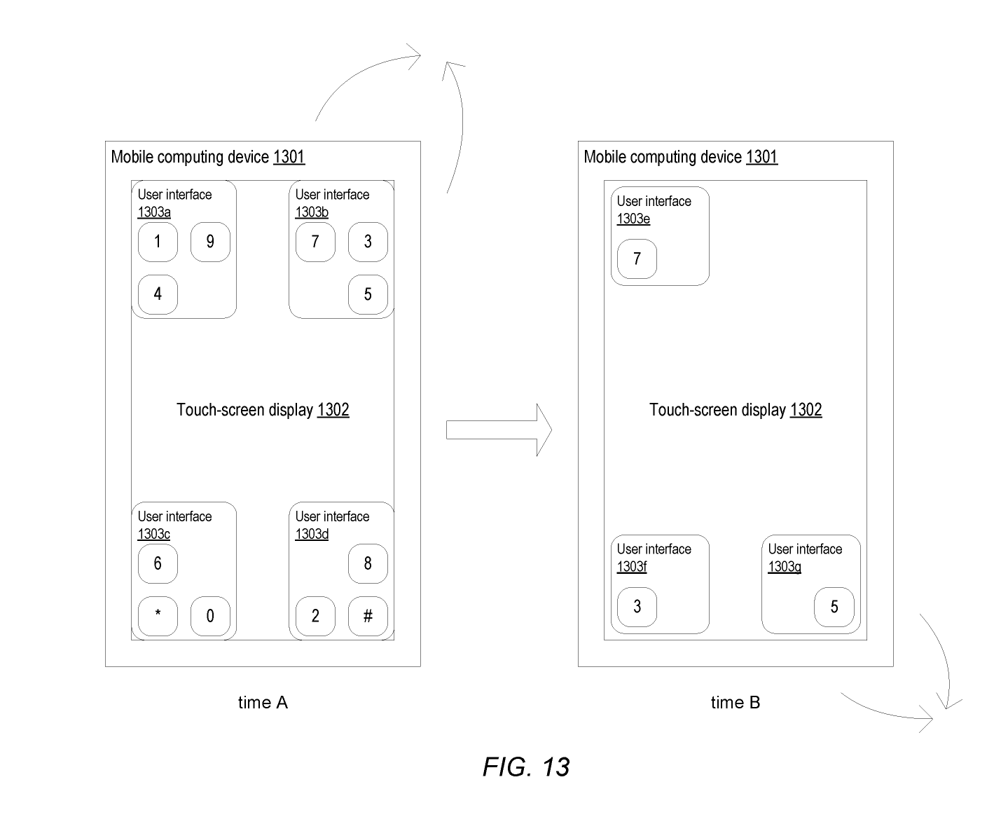

Moving now to FIG. 13, an example implementation of application 1210 in FIG. 12 running on a mobile device is depicted. Two representations of mobile computing device 1301 are shown, illustrating two respective points in time. In the illustrated embodiment, mobile computing device 1301 corresponds to mobile computing device 1201 described in regards to FIG. 12. Mobile computing device 1301 includes touch-screen display 1302, which displays user interface 1303, which includes parts 1303a through 1303d at time A, and parts 1303e through 1303g at time B.

In the illustrated embodiment, an application executing on mobile computing device 1301, such as, e.g., application 1210, determines that a user interface is to be displayed on touch-screen display 1302. Application 1210, starting with an interface template, randomizes characteristics of template including dividing the template into a number of parts and randomly assigning keys of the interface into the various parts. At time A, application 1210 causes user interface 1303 to be displayed on touch-screen display 1302 with each part of user interface 1303a through 1303d displayed in a respective corner of the display. Each of the parts, i.e., user interface 1303a-1303d, includes three keys corresponding to a 12-key keypad. In other embodiments, other types of interfaces may be used, such as, for example, alpha-numeric (e.g., QWERTY) keyboards or other types of symbols or character sets.

To select a particular key, a user tilts (e.g., lowers a height) of a particular corner of mobile computing device 1301 that is displaying the desired key. In the illustrated embodiment, for example, the user is selecting the number “5” key. At time A, the user tilts mobile computing device 1301 down at the corner that is displaying user interface 1303b, as indicated by the arrows, to select user interface 1303b. Application 1210 receives data from motion sensors in mobile computing device 1301 that indicates that the corner corresponding to user interface 1303b was selected. At time B, application 1210 redistributes the keys that are included in user interface 1303b (“7,” “3,” and “5”) into user interface parts 1303e, 1303f, and 1303g, respectively. Application 1210, in the illustrated embodiment, generates a new randomized value to determine which key (“7,” “3,” or “5”) goes into each of user interface parts 1303e-1303g. User interface parts 1303e-1303g are each displayed in a respective corner of touch-screen display 1302. The user may select the desired key (“5”) by again tilting mobile computing device 1301 towards the corner that is displaying the “5” key, as shown by the arrows, at time B. Since user interface 1303g includes only one key, application 1210 may determine that the 5 key has been selected and a value representative of this key (e.g., the value 5, or an ASCII code for the character “5”) is added to the user input sequence. To receive a next character of the passcode, application 1210 may, in some embodiments, cause the display to present user interface 1303 as it was shown at time A. In other embodiments, application 1210 may generate new randomized values for redistributing the various keys throughout user interface parts 1303a-1303d.

It is noted that the embodiment illustrated in FIG. 13 is one example for demonstrating disclosed concepts. In other embodiments, additional or different characteristics of a user interface may be altered. Although a twelve key keypad is illustrated, any suitable type of user interface may be used.

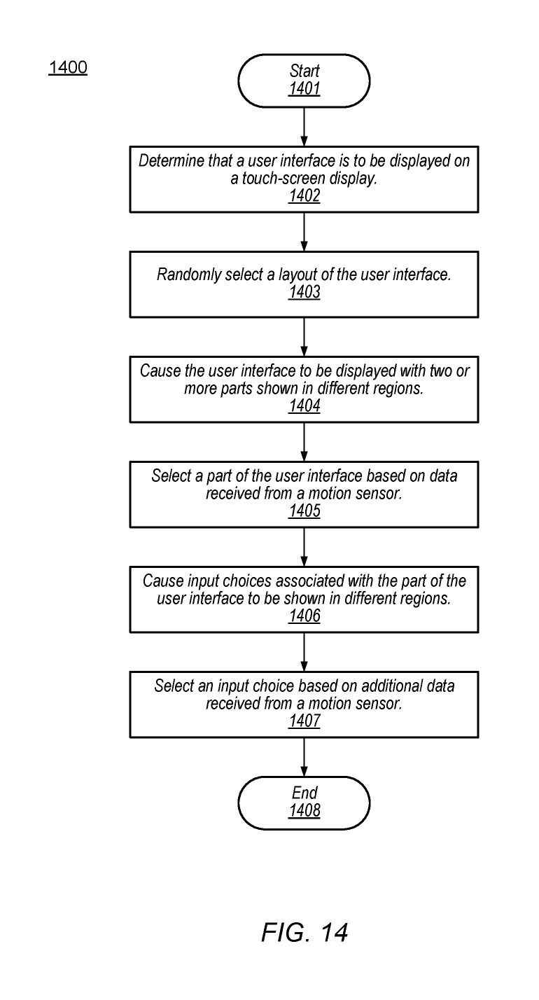

Proceeding to FIG. 14, a flow diagram is illustrated that depicts an embodiment of a method for displaying a user interface and receiving a corresponding user input sequence on a mobile computing device. In the illustrated embodiment, Method 1400 is applied to mobile computing device 1201 in FIG. 12. In other embodiments, method 1400 may be applied to any of the mobile computing devices disclosed herein. Referring to FIG. 12 and the method of FIG. 14, method 1400 begins in block 1401.

An application determines that a user interface is to be displayed on the display (block 1402). In the illustrated embodiment, application 1210 determines that user interface 1203 is to be displayed on touch-screen display 1202 in order to receive a passcode from a user. The determination may be based on input from a user (e.g., the user touched a “login” button in a menu presented on touch-screen display 1202), or from another application (e.g., a banking application activates application 1210 to retrieve the passcode from the user).

The application randomly selects a layout of the user interface (block 1403). Application 1210 retrieves a copy of user interface template 1211. Using random value generator 1212, application 1210 generates one or more randomized values, and based on one of these one or more values, alters the copy of user interface template 1211 by selecting a number of parts into which the copy is to be divided. Each character or symbol key that is included in user interface template 1211 is distributed, based on the one or more randomized values, into one of the parts of the copy of user interface template 1211.

The application causes the user interface to be displayed on the display such that the user interface is divided into two or more parts that are displayed in different regions of the display (block 1404). In addition to determining a number of parts and which keys are placed in which part, application 1210 determines a location for each part of the copy of user interface template 1211, placing each part into a different corner of touch-screen display 1202. Using display interface 1213, application 1210 sends the altered copy of user interface template 1211 to touch-screen display 1202, causing user interface 1203 to be displayed based on the altered copy.

The application selects a particular part of the user interface based on first data received from the one or more motion sensors (block 1405). A user of mobile computing device 1201, in the illustrated embodiment, may select a particular part of user interface 1203 by tilting the device towards the selected part (e.g., lowering the selected corner of the device). Using motion detection 1217, application 1210 detects the tilt towards the selected corner and determines which part of user interface 1203 is displayed in this corner. The part of user interface 1203 that is displayed in the selected corner is selected by application 1210.

The application causes a plurality of input choices associated with the particular part of the user interface to be displayed on the display such that each input choice of the plurality of input choices is displayed in a different region of the display (block 1406). In the illustrated embodiment, application 1210 takes the keys that are included in the selected part of user interface 1203 and distributes these keys into new parts of user interface 1203. Application 1210 may utilize the one or more randomized values to perform this distribution. Using display interface 1213, application 1210 sends the new parts of user interface 1203 to touch-screen display 1202, causing the display to replace the previous parts of the interface with these new parts.

The application selects a particular input choice based on additional data received from the one or more motion sensors (block 1407). The user may select a desired part of user interface 1203 by again tilting mobile computing device 1201 towards the desired part. If the selected part of user interface 1203 includes a single key, then this key is selected and a corresponding value is stored as part of the user's passcode. If the selected part includes a plurality of keys, then the method may repeat blocks 1406 and 1407. The method ends in block 1408.

It is noted that method 1400 in FIG. 14 is one example embodiment. Other embodiments may include additional operations. In some embodiments, one or more operations may be performed in parallel or in a different sequence.

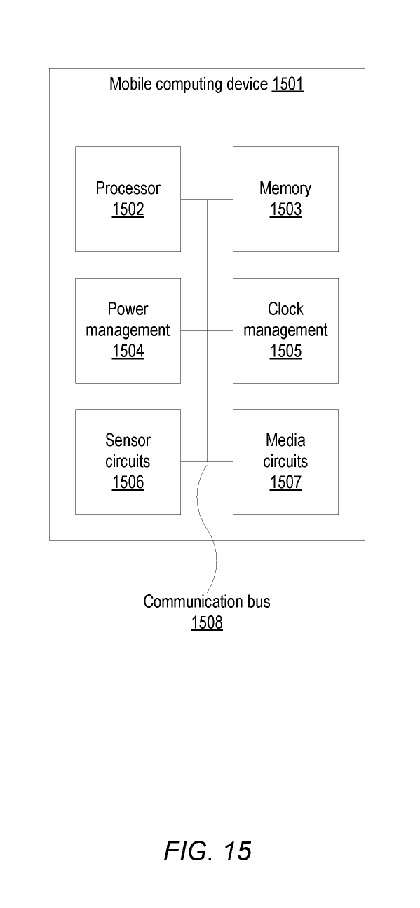

Turning to FIG. 15, a block diagram of an example mobile computing device is illustrated. Mobile computing device 1501, in various embodiments, may correspond to any of the mobile computing devices disclosed herein. In the illustrated embodiment, the Mobile computing device 1501 includes processor circuit 1502, memory circuit 1503, power management unit 1504, clock management circuits 1505, sensor circuits 1506, and media circuits 1507, each of which may be configured to send requests and data (collectively transactions) to the other circuit blocks using communication bus 1508. In various embodiments, mobile computer system 1501 may correspond to a tablet computer, a laptop computer, a smart phone, a wearable computing device, and the like.

Processor circuit 1502 may, in various embodiments, be representative of a general-purpose processor that performs computational operations. For example, processor circuit 1502 may be a central processing unit (CPU) such as a microprocessor, a microcontroller, an application-specific integrated circuit (ASIC), or a field-programmable gate array (FPGA). Processor circuit may, in some embodiments, be configured to execute instructions from one or more instruction set architectures (ISAs).

Memory circuit 1503, in some embodiments, may include volatile and/or non-volatile memory used to store and execute instructions and data for one or more application programs, such as, for example, application 110, application 210, or other application disclosed above. In various embodiments, memory circuit 1503 may include any suitable type of memory such as, for example, a Dynamic Random Access Memory (DRAM), a Static Random Access Memory (SRAM), a Read-only Memory (ROM), Electrically Erasable Programmable Read-only Memory (EEPROM), flash memory, other non-volatile memory, or a combination thereof. It is noted that in the embodiment illustrated in FIG. 15, a single memory circuit is depicted. In other embodiments, any suitable number of memory circuits may be employed.

Power management unit 1504 may be configured to generate a regulated voltage level in order to provide power to one or more of the circuit blocks included in mobile computing device 1501. In various embodiments, power management unit 1504 may include one or more voltage regulator circuits configured to generate the regulated voltage level based on an external power supply (not shown). It is noted that although a single internal power supply is depicted in the embodiment of FIG. 15, in other embodiments any suitable number of internal power supplies may be employed.

Clock management unit 1505 may include circuits used to generate, adjust, and distribute one or more clock signals to be used by the functional circuits included in mobile computing device 1501. In some embodiments, clock management unit 1505 may include one or more oscillator circuits for generating a reference clock signal with a particular frequency using a clock crystal (not shown), as well as circuits for generating system clock signals with other frequencies from the reference frequency, circuits such as phase-locked loops (PLLs) and/or frequency-locked loops (FLLs).

Sensor circuits 1506, in the illustrated embodiment, include circuits used to sense conditions or events occurring in or around mobile computing device 1501. For example, sensor circuits 1506 may include temperature sensors and light sensors. Sensor circuits 1506 may also include motion sensors, such as, e.g., motion sensors 104a and 104b in FIG. 1, as well as one or more touch sensors associated with touch-screen display 102.

In the illustrated embodiment, media circuits 1507 include circuits used to provide feedback or information to a user of mobile computing device 1501. Media circuits 1507 may include an audio processing circuit, one or more speakers, one or more microphones, one or more cameras, image processing circuits, and the like. Media circuits 1507 may also include touch-screen display 102 and vibration circuit 105 from FIG. 1.

Mobile computing device 1501 is one example of a mobile computing device that may be used in conjunction with the concepts disclosed herein. For clarity, only basic circuits associated with some mobile computing devices are illustrated. In other embodiments, additional functional circuits, and/or additional occurrences of the illustrated functional circuits may be included.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
causing display of a user interface on a touch-screen display of a mobile computing device, wherein the mobile computing device includes one or more motion sensors configured to detect movement of the mobile computing device;
in response to detection of a particular touch input to the user interface, causing generation of a randomized value associated with the particular touch input of the mobile computing device; and
causing a first vibration of the mobile computing device in response to the particular touch input, wherein at least one characteristic of a plurality of characteristics of the first vibration is randomized based on the randomized value.

2. The method of claim 1, wherein the at least one characteristic is selected from the group consisting of: vibration duration, vibration intensity, and vibration pattern.

3. The method of claim 1, wherein causing generation of a randomized value comprises using, by an application executing on the mobile computing device, program instructions to generate the randomized value.

4. The method of claim 1, wherein causing generation of the randomized value comprises sending, by a processor of the mobile computing device, a request to generate the first vibration; and
wherein causing the first vibration comprises generating, by a vibration circuit of the mobile computing device, the randomized value, and using, by the vibration circuit, the randomized value to produce the at least one characteristic.

5. The method of claim 1, wherein causing generation of a randomized value comprises:
requesting, by an application executing on the mobile computing device, a random number from a random number circuit; and
receiving, from the random number circuit, the randomized value.

6. The method of claim 1, further comprising, during a subsequent display of the user interface, in response to detecting a different touch input with a corresponding value that is the same as a value corresponding to the particular touch input, causing a second vibration of the mobile computing device in response to the different touch input such that the second vibration differs in one or more characteristics as compared to the first vibration.

7. A non-transitory, computer-readable medium storing instructions that, when executed by a mobile computing device having a touch-screen display and one or more sensors configured to detect motion of the mobile computing device, cause the mobile computing device to perform operations comprising:
in response to a request from an application executing on the mobile computing device for user input, causing a user interface to be displayed on the touch-screen display;
in response to detection of a particular touch input to the user interface, causing a randomized value to be generated; and
causing a first vibration of the mobile computing device, the first vibration having at least one characteristic that is randomized based on the randomized value, wherein the first vibration affects an output of one or more motion sensors included in the mobile computing system.

8. The computer-readable medium of claim 7, wherein the at least one characteristic is selected from the group consisting of: vibration duration, vibration intensity, and vibration pattern.

9. The computer-readable medium of claim 7, wherein for a given touch input to the user interface, the at least one characteristic to be randomized is randomly selected from a plurality of different vibration characteristics.

10. The computer-readable medium of claim 7, wherein displaying the user interface includes selecting one or more layout characteristics to alter relative to a template of the user interface.

11. A method, comprising:
determining, by an application executing on a mobile computing device having a touch-screen display and one or more motion sensors that detect movement of the mobile computing device, that a user interface is to be displayed on the touch-screen display;
randomly selecting, by the application, a plurality of layout characteristics of a template of the user interface to alter; and
causing, by the application, the user interface to be displayed on the touch-screen display with a layout based on the template and the altered plurality of layout characteristics.

12. The method of claim 11, wherein a first of the plurality of layout characteristics to be altered is a location of the user interface on the touch-screen display, wherein the location is randomly selected.

13. The method of claim 11, wherein a first of the plurality of layout characteristics to be altered is a size of the user interface on the touch-screen display, wherein the size is randomly selected.

14. The method of claim 11, wherein a first of the plurality of layout characteristics to be altered is a division of the user interface, wherein the user interface is displayed such that the user interface is divided into two or more parts that are displayed in different regions of the touch-screen display.

15. The method of claim 14, wherein a number of the two or more parts is randomly determined.

16. The method of claim 14, wherein a placement each of the two or more parts is randomly determined.

17. The method of claim 11, further comprising:
randomly selecting, by the application during an input sequence, a particular portion of the user interface;
providing, by the application, a visual indication that the particular portion of the user interface is to be touched by a user;
receiving, by the application, a touch input corresponding to the particular portion of the user interface; and
excluding, by the application, data corresponding to the touch input from received inputs during the input sequence.

18. The method of claim 11, further comprising, in response to determining a touch input has been received, causing, by the application, a vibration of the mobile computing device, wherein at least one characteristic of the vibration is randomly determined.

19. The method of claim 18, further comprising randomly determining which vibration characteristics to randomize for different touch inputs of an input sequence.

20. The method of claim 11, wherein a first of the plurality of layout characteristics is an order of keys within the user interface, and wherein a second of the plurality of layout characteristics is selected from the group consisting of: interface size, interface location, division of the user interface.
